(19) United States
(12) Patent Application Publication
(10) Pub. No.: US 2010/0022338 A1
(43) Pub. Date: Jan. 28, 2010

(54) PIVOT TYPE TENSIONER FOR TIMING CHAIN SYSTEMS

(75) Inventors: Lucian BOTEZ, NOVI, MI (US); Jeff HEWITT, WINDSOR (CA)

Correspondence Address: LUCAS & MERCANTI, LLP, 475 PARK AVENUE SOUTH, 15TH FLOOR, NEW YORK, NY, 10016, US

(73) Assignee: SCHAEFFLER KG, Herzogenaurach (DE)

(21) Appl. No.: 12/507,218

(22) Filed: Jul. 22, 2009

Related U.S. Application Data
(60) Provisional application No. 61/083,011, filed on Jul. 23, 2008.

(51) Int. Cl. F16H 7/08

(52) U.S. Cl. 474/111

(57) ABSTRACT

The tensioning device has a base element and a tension shoe which are connected using fork arms to the pivot axle. Retention surfaces on the base element and the tension shoe and a locking rib and locking channel provide a locking mechanism between the base element and tension shoe.

### FIELD OF THE INVENTION

The present Invention relates to tensioning devices for traction means and, more specifically, for tensioning devices used for timing chain systems, such as the type used between a crankshaft and a camshaft for timing of the valve openings in internal combustion engines.

### BACKGROUND OF THE INVENTION

Chain tensioning devices are known, see for example, U.S. Pat. No. 6,406,391. In such devices, a tension shoe is mounted on a pivot axle for pivoting relative to a base element. A spring means is arranged between the tension shoe and the base element to urge the tension shoe against the chain. The tension shoe has a mounting eye with a radial mounting aperture into which the pivot axle is mounted. The pivot axle is generally fixed to the base elements.

Retention surfaces on both the tension shoe and the base element help to retain the tension shoe on the base element, however, separation can occur between the tension shoe and the base element.

### OBJECT OF THE INVENTION

It is the object of the Invention to improve the locking mechanism between the base element and the tension shoe and prevent separation of the tension shoe from the base element.

These and other objects of the present Invention will be more readily understood by reference to the following description of the Invention.

### SUMMARY OF THE INVENTION

The objects of the present Invention are obtained by using a locking mechanism comprising a locking rib on the base element and a locking channel on the tension shoe wherein the locking rib and the locking channel slidably engage and are extensions of the retention surfaces of the tension shoe and the base element. The locking rib and the locking channel are arched so as to form coplanar surfaces with the retaining surfaces. The locking mechanism is located approximately opposite the radial mounting aperture of the mounting eyes. By locating the locking mechanism approximately opposite the radial mounting aperture of the mounting eye, a good locking joint is formed between the tension screw and the base element.

The tension device of the Invention can be defined as a tensioning device for a traction means comprising:
a tension shoe that tensions the traction means;
a base element on which the tension shoe is mounted for pivoting on a pivot axle;
a spring means arranged between the tension shoe and the base element urging the tension shoe against the traction means;
two horseshoe-shaped spaced-apart forked arms, each having a mounting eye with a radial mounting aperture for radially receiving the pivot axle;
a radial projection in which the pivot axle is mounted, the pivot axle extending out from both sides of the radial projection, the radial projecting overlapped by both forked arm and allowing a snap engagement between the mounting eyes and the pivot axle, one of either the radial projections or the forked arms mounted on one of either the tensioning shoe or the base element, and the other of the radial projection and the forked arms mounted on the other of the tension shoe and base element;
corresponding arched retention surfaces which extend coaxially with the pivot axle and which are situated opposite each other in an operation-dependent pivoting range of the tensioning device, one of the arched retention surfaces on the base element and the other of the arched retention surfaces on the tension shoe;
a locking rib on the base element, the arched locking rib having a concave inner locking rib surface that is coaxial with the pivot axle, and extends in a coplanar manner from the one arched retention surface;
an arch locking channel in the tension shoe, the arched locking channel having a convex inner locking channel surface that is coaxial with the pivot axle and extends in a coplanar manner from the other arched retention surface;
the arched locking rib slidable within the arched locking channel and a center plane of the radial mounting aperture intersects the locking rib in an operation-dependent pivoting range of the tensioning device to prevent the radial displacement of the pivot axle from the radial mounting aperture.

Preferably, the radial projection is on the base element and the forked arms are on the tension shoe.

Preferably, the radial mounting aperture has a constriction with a width smaller than the pivot axial diameter to allow for a snap connection between the mounting eye and the pivot axle. It is also preferred that one or more of the sides of the locking channel has a cap to close off the sides of the channel and add additional locking security to the tensioning device.

Suitably, the tension shoe and the base element are made of any material, for example, plastic, aluminum and steel.

### BRIEF DESCRIPTION OF THE DRAWINGS

These and other aspects of the present Invention may be more readily understood by reference to one or more of the following drawings:

FIG. 1 is a view of the chain tensioner according to the present Invention;

FIG. 2 is a top view of the chain tensioner according to the Invention of FIG. 1;

FIG. 3 is a side view of an alternative embodiment of the chain tensioner of the present Invention;

FIG. 4 is a top view of the chain tensioner of FIG. 3;

FIG. 5 illustrates the tension shoe with open sides for the locking channel;

FIG. 6 illustrates the tension shoe with a cap closing one of the sides of the locking channel;

FIG. 7 illustrates the tension shoe with a cap on both sides of the locking channel; and

FIG. 8 illustrates the assembly of the chain tensioner according to the present Invention.

### DETAILED DESCRIPTION OF THE DRAWINGS

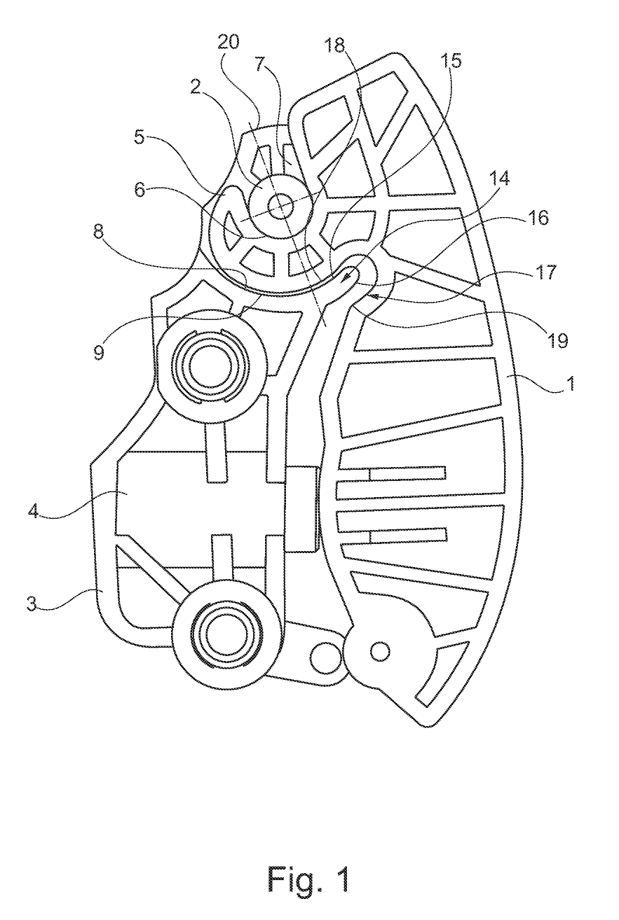

FIG. 1 illustrates the chain tensioner of the present Invention having tension shoe 1 mounted on pivot axle 2 for pivoting relative to base element 3. Between tension shoe 1 and base element 3 is spring element 4 which is supported at one end by base element 3 and which, at the other end, urges tension shoe 1 against a chain, not shown.

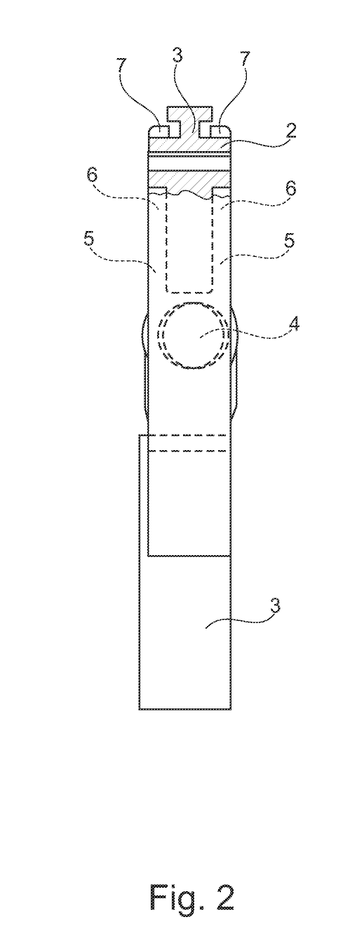

As can be seen in FIG. 2, pivot axle 2 is one piece with base element 3. Pivot axle 2 projects from base element 3 on both sides. Tension shoe 1 comprises two spaced apart forked arms 5, each of which has a mounting eye 6. Each mounting eye 6 has a radial mounting aperture 7 and base element 3 is arranged between forked arms 5. Forked arm 5 overlaps base element 3 radially and receives the ends of pivot axle 2 in mounting eye 6. In this way, an axial fixing of tension shoe 1 relative to base element 3 is obtained.

Base element 3 has a concave retaining surface 8 and tension shoe 1 has a convex retention surface 9. Both retention surfaces 8 and 9 are arranged coaxially with pivot axle 2 and are situated opposite each other. From FIG. 1 it can be seen that in the position shown, pivot axle 2 is fixed in mounting eye 6 and held in place partially by retention surfaces 8 and 9 because surfaces 8 and 9 press against each other.

Locking rib 14 extends from base element 3 and follows the arch of retention surface 8. Locking rib 14 extends into tension shoe 1. Locking rib 14 has a concave inner rib surface 15 and a convex outer rib surface 16 that follows the arch of retention surface 8. Locking channel 17 extends into tension shoe 1 following the arch of retention surface 9. Locking channel 17 has a convex inner channel surface 18 and a concave outer channel surface 19 that follows the arch of retention surface 9.

Locking rib 14 moves within locking channel 17 and, as shown in FIG. 1, the locking mechanism comprising locking rib 14 and locking channel 17 is approximately opposite mounting aperture 7 such that mounting aperture center plane 20 intersects locking rib 14 as shown in FIG. 1. This location of the locking mechanism ensures good locking between tension shoe 1 and base element 3 because concave inner locking rib surface 15 presses against convex inner locking channel surface 18.

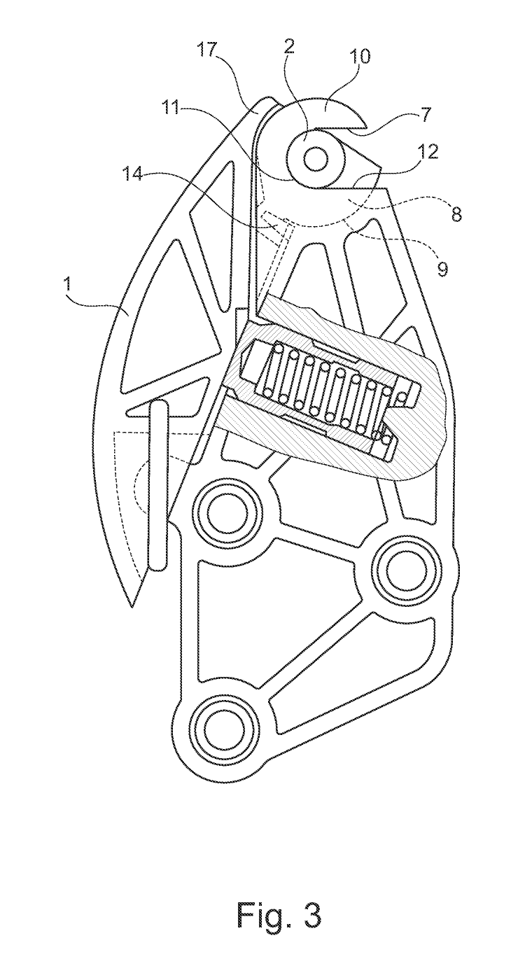

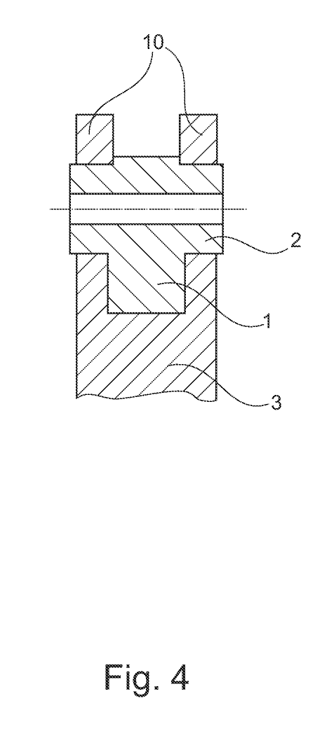

The tensioning device according to the Invention as illustrated in FIGS. 3 and 4 differ from FIGS. 1 and 2 primarily because pivot axle 3 is fixed on tension shoe 1 and projects from tension shoe 1 on both sides.

Base element 3 comprises forked arms 10 between which tension shoe 1 is arranged. Each forked arm 10 has a mounting eye 11 and each mounting eye 11 has a radial mounting aperture 12. Mounting eye 11 receives the projecting ends of pivot axle 2. It can be seen from FIG. 3 that retaining surfaces 8 and 9, in conjunction with locking rib 14 and locking channel 17, that radial outward displacement of pivot axle 2 is impossible because of the interaction of the various surfaces.

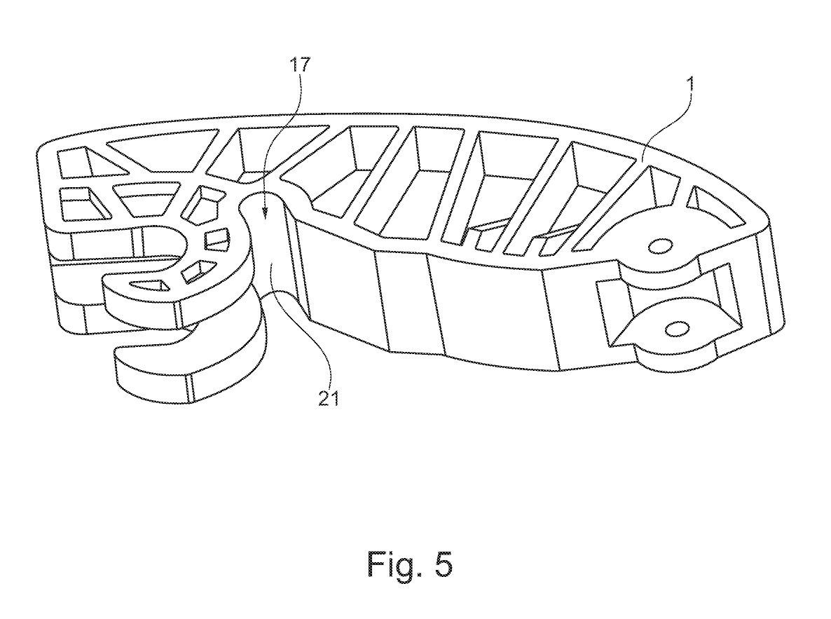

FIG. 5 illustrates tension shoe 1 having locking channel 17 wherein both sides of locking channel 17 with two open sides 21.

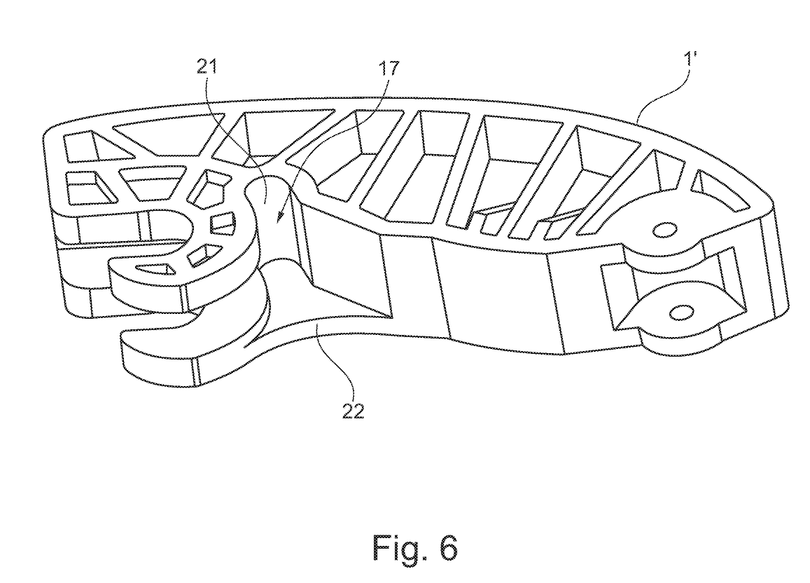

FIG. 6 illustrates tension shoe 1′ having locking channel 17 with one open side 21 and a cap 22 closing the other side of locking channel 17.

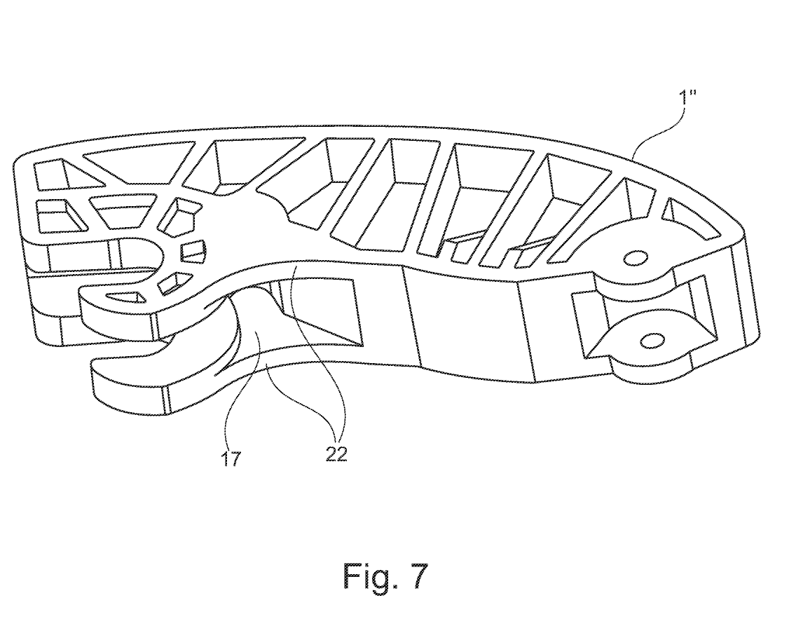

FIG. 7 illustrates tension shoe 1″ with locking channel 17 having two cap 22 closing both sides of locking channel 17.

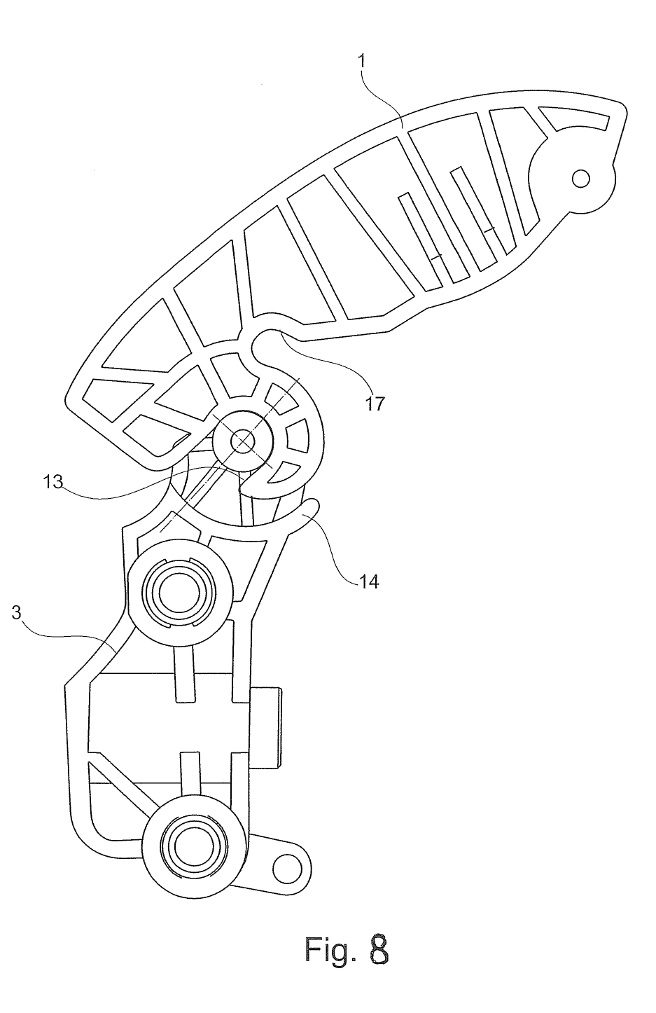

Finally, FIG. 8 shows tension device according to FIG. 1 where tension shoe 1 is pivoted relative to base element 3 so that retention surfaces 89 and locking rib 14 and locking channel 17 are disengaged from one another. In this position, tension shoe 1 is pushed without any problem onto pivot axle 2. Also, it can be seen constriction 13 has a width smaller than the diameter of pivot axle 2. During the insertion of pivot axle 2 into mounting eye 6, fork arm 5 is deformed elastically so that pivot axle 2 can pass construction 13 and snap fit into mounting eye 6.

### REFERENCE CHARACTERS

1. Tension Shoe
2. Pivot axle
3. Base element
4. Spring means
5. Fork arms
6. Mounting eye
7. Mounting aperture
8. Retention surface
9. Retention surface
10. Fork Arms
11. Mounting eye
12. Mounting aperture
13. Constriction
14. Locking rib
15. Inner locking rib surface
16. Outer locking rib surface
17. Locking channel
18. Inner locking channel surface
19. Outer locking channel surface
20. Mounting aperture center plane
21. Open side
22. Cap

What we claim is:

1. A tensioning device for a traction means comprising:
a tension shoe that tensions the traction means;
a base element on which the tension shoe is mounted for pivoting on a pivot axle;
a spring means arranged between the tension shoe and the base element urging the tension shoe against the traction means;
two horseshoe-shaped spaced-apart forked arms, each having a mounting eye with a radial mounting aperture for radially receiving the pivot axle;
a radial projection in which the pivot axle is mounted, the pivot axle extending out from both sides of the radial projection, the radial projecting overlapped by both forked arm and allowing a snap engagement between the mounting eyes and the pivot axle, one of either the radial projections or the forked arms mounted on one of either the tensioning shoe or the base element, and the other of the radial projection and the forked arms mounted on the other of the tension shoe and base element;
corresponding arched retention surfaces which extend coaxially with the pivot axle and which are situated opposite each other in an operation-dependent pivoting range of the tensioning device, one of the arched retention surfaces on the base element and the other of the arched retention surfaces on the tension shoe;
a locking rib on the base element, the arched locking rib having a concave inner locking rib surface that is coaxial with the pivot axle, and extends in a coplanar manner from the one arched retention surface;
an arch locking channel in the tension shoe, the arched locking channel having a convex inner locking channel surface that is coaxial with the pivot axle and extends in a coplanar manner from the other arched retention surface;
the arched locking rib slidable within the arched locking channel and a center plane of the radial mounting aperture intersects the locking rib in an operation-dependent pivoting range of the tensioning device to prevent the radial displacement of the pivot axle from the radial mounting aperture.

2. The device of claim 1, wherein
the radial projection is on the base element and the forked arms are on the tension shoe.

3. The device of claim 1, wherein
the radial projection is on the tension shoe and the forked arms are on the base element.

4. The device of claim 1, wherein
the radial mounting aperture has a constriction with a width smaller than the pivot axle diameter.

5. The device of claim 1, wherein
at least one side of the locking channel has a cap.

6. The device of claim 1, wherein
both sides of the locking channel have a cap.
